(19) United States
(12) Patent Application Publication
(10) Pub. No.: US 2015/0174918 A1
(43) Pub. Date: Jun. 25, 2015

(54) RECORDING APPARATUS

(71) Applicant: SEIKO EPSON CORPORATION, Tokyo (JP)

(72) Inventors: Kazuya TAJIMA, Matsumoto (JP); Satoru KATAGAMI, Matsumoto (JP); Kazuaki SAKURADA, Suwa (JP); Kentaro MIYAZAKI, Matsumoto (JP); Yuichi WASHIO, Matsumoto (JP)

(21) Appl. No.: 14/536,172

(22) Filed: Nov. 7, 2014

(30) Foreign Application Priority Data
Dec. 20, 2013 (JP) 2013-263481

(51) Int. Cl. B41J 11/00

(52) U.S. Cl. CPC B41J 11/002; B41J 11/0045

(57) ABSTRACT

An recording apparatus includes a rotating drum with which a recording medium is fed along an outer peripheral surface, a reaction solution application section configured to apply a reaction solution onto the recording medium at a first position in an outer peripheral surface feed path that runs along the outer peripheral surface of the rotating drum, and an ink ejecting section configured to eject an ink that reacts with the reaction solution onto the recording medium onto which the reaction solution has been applied, at a second position that is more on a downstream side in a direction of feeding of the recording medium than the first position, in the outer peripheral surface feed path.

### CROSS-REFERENCE TO RELATED APPLICATIONS

This application claims priority to Japanese Patent Application No. 2013-263481 filed on Dec. 20, 2013. The entire disclosure of Japanese Patent Application No. 2013-263481 is hereby incorporated herein by reference.

### BACKGROUND

1. Technical Field

The present invention relates to a recording apparatus that records by ejecting ink onto a recording medium.

2. Related Art

Conventionally known is an inkjet recording apparatus provided with: a plurality of impression cylinders, with which a recording medium is fed along an outer peripheral surface; a treatment solution application section for applying a treatment solution to a coated paper for printing, at a first position in one outer peripheral surface feed path, that runs along the outer peripheral surface of one impression cylinder (a treatment solution drum); and an ink droplet ejection section for ejecting droplets of an ink that reacts with the treatment solution, onto the coated paper for printing to which the treatment solution has been applied, at a second position in another outer peripheral surface feed path, that runs along the outer peripheral surface of another impression cylinder (an image-rendering drum) different from the one impression cylinder (see Japanese laid-open patent publication No. 2010-099968).

### SUMMARY

In the conventional inkjet recording apparatus, the first position at which the treatment solution is applied to the coated paper for printing by the treatment solution application section and the second position at which the droplets of ink are ejected onto the coated paper for printing by the ink droplet ejection section are provided separately to individually different outer peripheral surface feed paths that run along the respective outer peripheral surfaces of two impression cylinders, and the first position and the second position are not provided to the same outer peripheral surface feed path that runs along the outer peripheral surface of one drum.

The present invention addresses the problem of providing a recording apparatus with which it is possible to shorten the distance between a position at which a reaction solution is applied to a recording medium and a position at which ink is ejected, in a path of feeding of the recording medium.

A recording apparatus of one aspect of the invention comprises a drum with which a recording medium is fed along an outer peripheral surface, a reaction solution application section configured to apply a reaction solution onto the recording medium at a first position in an outer peripheral surface feed path that runs along the outer peripheral surface of the drum, and an ink ejecting section configured to eject an ink that reacts with the reaction solution onto the recording medium onto which the reaction solution has been applied, at a second position that is more on a downstream side in a direction of feeding of the recording medium than the first position, in the outer peripheral surface feed path.

According to this configuration, the first position at which the reaction solution is applied to the recording medium by the reaction solution application section and the second position at which the ink is ejected onto the recording medium by the ink ejecting section are provided to the same outer peripheral surface feed path that runs along the outer peripheral surface of a singular drum. For this reason, it is possible to shorten the distance between the first position at which the reaction solution is applied to the recording medium and the second position at which the ink is ejected, in the path of feeding of the recording medium.

In such a case, a preferred configuration is to be further provided with an evaporation promotion section which has at least one of a blower section configured to blow air onto the recording medium at a third position that is more on the downstream side of the direction of feeding than the first position and more on an upstream side of the direction of feeding than the second position in the outer peripheral surface feed path, and a medium heating section configured to heat the recording medium at the third position, and the evaporation promotion section is configured to promote evaporation of a solvent of the reaction solution having been applied to the recording medium.

When the ink is ejected onto the recording medium in a state where a large amount of the solvent of the reaction solution remains on the recording medium, then the remaining solvent provokes a flowing of the ink on the recording medium, and lowers the fixing position accuracy for the ink on the recording medium.

By contrast, according to the present configuration, the evaporation of the solvent of the reaction solution is promoted by the evaporation promotion section at the third position, after the reaction solution has been applied to the recording medium at the first position and before the ink is ejected at the second position. Therefore, the ink will be ejected, in a state in which the solvent of the reaction solution has evaporated to some extent, onto the recording medium onto which the reaction solution had been ejected. As such, ejecting of the ink onto the recording medium in a state where a large amount of the solvent of the reaction solution remains on the recording medium is curbed. Therefore, the fixing position accuracy of the ink on the recording medium can be improved.

In such a case, preferably, the evaporation promotion section has at least the blower section.

According to this configuration, the air is blown from the blower section onto the recording medium onto which the reaction solution has been applied. This makes it possible to efficiently evaporate the solvent of the reaction solution.

In such a case, preferably, the blower section is configured to blow the air in a direction substantially orthogonal to the direction of feeding.

According to this configuration, it is possible to curb blowing of the air from the blower section to the first position, which is more on the upstream side in the direction of feeding than the third position, and also it is possible to curb blowing of the air from the blower section onto the second position, which is more on the downstream side in the direction of feeding than the third position. Therefore, it is possible to prevent the air coming from the blower section from disrupting the application of the reaction solution by the reaction solution application section at the first position or the ejecting of ink by the ink ejecting section at the second position.

In such a case, preferably, the blower section includes a blowing and heating section configured to heat the air that is blown onto the recording medium.

According to this configuration, air that has been heated is blown from the blower section onto the recording medium to which the reaction solution has been applied. This makes it possible to more effectively evaporate the solvent of the reaction solution.

In such a case, preferably, the evaporation promotion section further includes a first heat insulating material provided more on the downstream side in the direction of feeding than the first position and more on the upstream side in the direction of feeding than the third position.

According to this configuration, in a case where the heated air is blown onto the recording medium at the third position, providing the first heat insulating material curbs heating of the first position in association therewith. As such, the air coming from the blower section can be prevented from disrupting the application of the reaction solution by the reaction solution application section at the first position.

In such a case, preferably, the evaporation promotion section further includes a second heat insulating material provided more on the downstream side in the direction of feeding than the third position and more on the upstream side in the direction of feeding than the second position.

According to this configuration, in a case where the heated air is blown onto the recording medium at the third position, providing the second heat insulating material curbs heating of the second position in association therewith. As such, the air coming from the blower section can be prevented from disrupting the ejecting of the ink by the ink ejecting section at the second position.

In such a case, preferably, the reaction solution application section has a plurality of reaction solution ejecting nozzles that are configured to eject the reaction solution and arranged so as to correspond to a width of the drum.

According to this configuration, the reaction solution application section can eject the reaction solution onto the entire width of the recording medium without having to scan in the width direction of the recording medium.

In such a case, preferably, the ink ejecting section has a plurality of ink ejecting nozzles that are configured to eject the ink and arranged so as to correspond to a width of the drum.

According to this configuration, the ink ejecting section can eject the ink onto the entire width of the recording medium without having to scan in the width direction of the recording medium.

In such a case, preferably, the drum is rotated by the recording medium being fed.

In such a case, a preferred configuration is to be further provided with a medium feed-out section configured to feed the recording medium out toward the drum, and a medium take-up section configured to take up the recording medium having been fed from the drum.

### BRIEF DESCRIPTION OF THE DRAWINGS

Referring now to the attached drawings which form a part of this original disclosure:

FIG. 1 is a configurational diagram of a recording apparatus as in one embodiment of the present invention;

FIG. 2 is a drawing illustrating a head unit and reaction solution application unit in a recording apparatus; and

FIG. 3 is a perspective view around a rotating drum in a recording apparatus.

### DETAILED DESCRIPTION OF EXEMPLARY EMBODIMENTS

A recording apparatus as in an embodiment of the present invention shall now be described below, with reference to the accompanying drawings. This recording apparatus is one that records by ejecting a reaction solution that reacts with ink onto an elongated print medium such as label paper, and then ejecting ink thereonto. A variety of materials are available for use as a recording medium, such as papers or films.

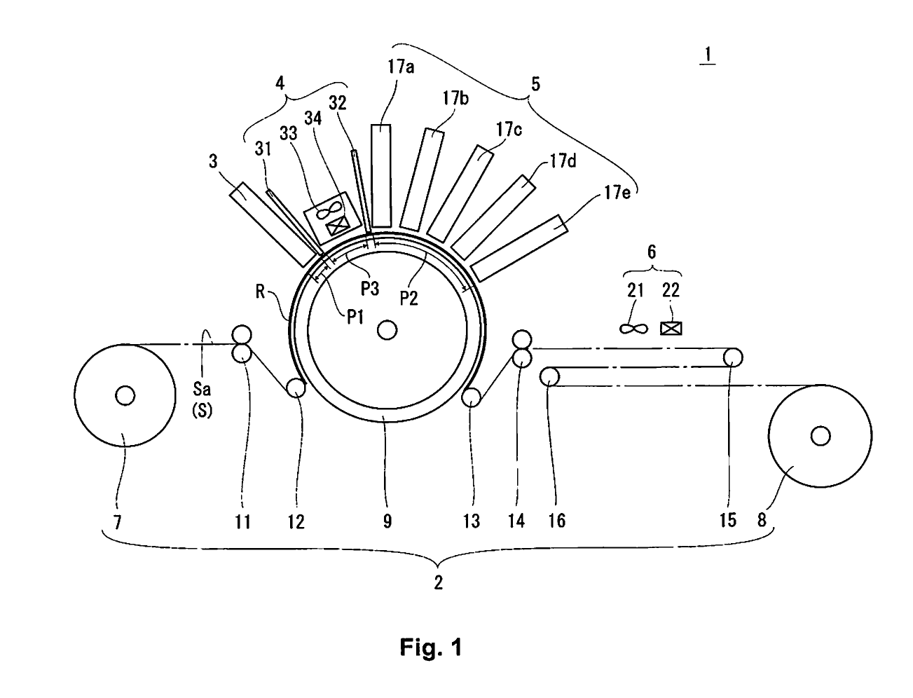

As illustrated in FIG. 1, the recording apparatus 1 is provided with: a feed section 2 for feeding a recording medium; a reaction solution application section 3 for ejecting a reaction solution onto the recording medium S; an evaporation promotion section 4 for promoting evaporation of a solvent of the reaction solution having been ejected onto the recording medium S; an ink ejecting section 5 for ejecting ink onto the recording medium S onto which the reaction solution has been ejected; and a drying section 6 for drying the recording medium S onto which the ink has been ejected.

The feed section 2 feeds the recording medium S in a roll-to-roll format. The feed section 2 is provided with a feed-out reel 7 and take-up reel 8, a rotating drum 9 provided at substantially the middle of a path of feeding, and a plurality of rollers provided to the path of feeding.

The feed-out reel 7 is one example of a “medium feed-out section” in the claims. The rotating drum 9 is one example of a “drum” in the claims. The take-up reel 8 is one example of a “medium take-up section” in the claims.

Provided as the plurality of rollers are an upstream feed roller 11, an upstream guide roller 12, a downstream guide roller 13, a downstream feed roller 14, a first loop-back roller 15, and a second loop-back roller 16, in the stated order from an upstream side in a direction of feeding. Rotatingly driving the feed-out reel 7, the upstream feed roller 11, the downstream feed roller 14, and the take-up reel 8 causes the recording medium S to be fed out from the feed-out reel 7, fed in the direction of feeding along the circumference of the rotating drum 9, and taken up at the take-up reel 8. The first loop-back roller 15 and the second loop-back roller 16 are provided to the drying section 6.

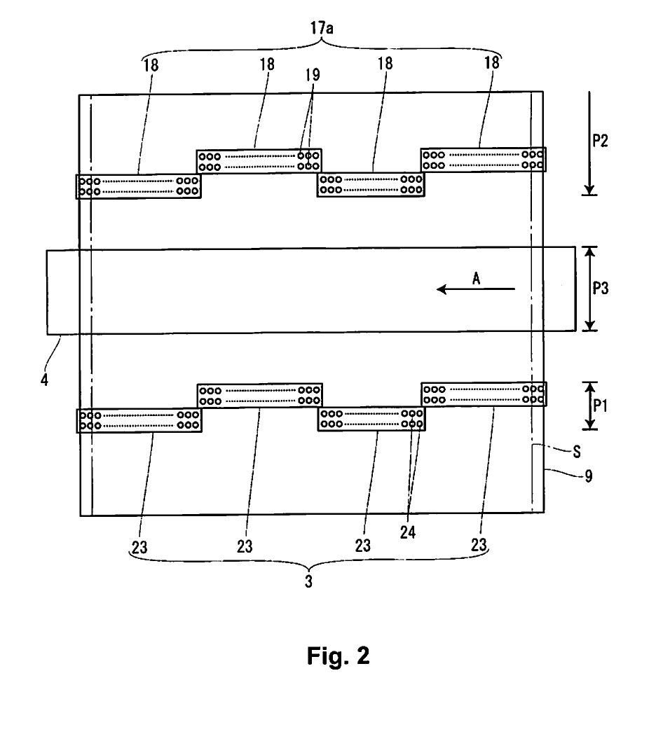

The rotating drum 9 is a cylindrical drum that is rotatably supported by a support mechanism (not shown). The rotating drum 9 supports the recording medium S on an outer peripheral surface from the reverse surface side, i.e., the opposite side to a recording surface Sa. When the recording medium S is fed along the outer peripheral surface thereof, the rotating drum 9 is rotatingly driven by the frictional force between the outer peripheral surface and the recording medium S. The dimension of the rotating drum 9 in the axial direction is slightly larger than the width of the recording medium S at the widest (see FIG. 2).

The name “outer peripheral surface feed path R” is given to the path of feeding along the outer peripheral surface of the rotating drum 9 out of the path of feeding of the recording medium S that reaches from the feed-out reel 7 to the take-up reel 8. FIG. 1 illustrates the outer peripheral surface feed path R with a solid thick line. The reaction solution application section 3 ejects a reaction solution onto the recording medium S at a first position P1 in the outer peripheral surface feed path R. The ink ejecting section 5 ejects ink onto the recording medium S at a second position P2 that is more on the downstream side in the direction of feeding than the first position P1, in the outer peripheral surface feed path R. The evaporation promotion section 4 blows air onto the recording medium S at a third position P3 that is more on the downstream side in the direction of feeding than the first position P1 and more on the upstream side in the direction of feeding than the second position P2, in the outer peripheral surface feed path R.

The ink ejecting section 5 is provided with a first head unit 17a, a second head unit 17b, a third head unit 17c, a fourth head unit 17, and a fifth head unit 17e, in the stated order from the upstream side in the direction of feeding.

As illustrated in FIG. 2, each of the head units 17 is provided with, for example, four ink ejecting heads 18. Each of the ink ejecting heads 18 is one that discharges ink in an inkjet format, and has a plurality of ink ejecting nozzles 19. The ink ejecting nozzles 19 of the four ink ejecting heads 18 are arranged so as to correspond to the width of the rotating drum 9. That is to say, each of the head units 17 is line-type. This makes it possible for each of the head units 17 to eject ink onto the entire width of the recording medium S without scanning in the width direction of the recording medium S, as is the case with the serial type.

The first head unit 17a ejects white ink. The second head unit 17b ejects black ink. The third head unit 17c ejects yellow ink. The fourth head unit 17d ejects cyan ink. The fifth head unit 17e ejects magenta ink. In a case where, for example, the recording medium S is constituted of a transparent film material, then the white ink is ejected by the first head unit 17a onto the entire surface to form an underlying layer of white, and then the respective colors of ink are ejected by the second head unit 17b through fifth head unit 17e onto the formed underlying layer, thus forming a color image. In a case where the recording medium S is constituted of a paper material, then no white ink need be ejected by the first head unit 17a, with the color image then being formed by the respective colors of ink ejected by the second head unit 17b through fifth head unit 17e.

It shall be readily understood that the colors of ink ejected by each of the head units 17 are not particularly limited. The number of the head units 17s, i.e., the number of colors of ink ejected by the ink ejecting section is likewise not particularly limited.

Though not particularly limited, provided that there be a reaction with the reaction solution ejected by the reaction solution application section 3, the ink ejected by each of the head units 17 is preferably a solvent into which a coloring material has been dispersed. A suitably usable example of an ink with which a coloring material has been dispersed into a solvent is a pigment ink, in which a pigment is used as the coloring material.

The drying section 6 is provided between the rotating drum 9 and the take-up reel 8. The drying section 6 has a drying section fan 21 and a drying section heater 22 and causes the recording medium S to dry by blowing hot air substantially in parallel with the recording surface Sa from the side onto the recording medium S onto which the reaction solution and the ink have been ejected. In the drying section 6, the path of feeding of the recording medium S is looped back by the first loop-back roller 15 and the second loop-back roller 16. For this reason, the hot air can be efficiently applied to the recording medium S without providing a wide space for the drying section 6.

The drying section 6 may dry the recording medium S by sending room-temperature air using only the drying section fan 21, or may dry the recording medium S by heating the recording medium S using only the drying section heater 22.

As illustrated in FIG. 2, the reaction solution application section 3 is provided with, for example, four reaction solution ejecting heads 23. Each of the reaction solution ejecting heads 23 is one that ejects the reaction solution in an inkjet format, and has a plurality of reaction solution ejecting nozzles 24. The reaction solution ejecting nozzles 24 of the four reaction solution ejecting heads 23 are arranged so as to correspond to the width of the rotating drum 9. That is to say, the reaction solution application section 3 is line-type. This makes it possible for the reaction solution application section 3 to eject the reaction solution onto the entire width of the recording medium S without scanning in the width direction of the recording medium S, as is the case with the serial type.

However, the reaction solution application section 3 may eject the reaction solution onto the entire surface of the recording medium S, or may eject the reaction solution only onto a region where the ink is ejected by the ink ejecting section 5.

The reaction solution is not particularly limited, provided that there be a reaction with the ink ejected by each of the head units 17. In a case where an ink with which a coloring material is dispersed in a solvent is used, then the reaction solution preferably is a solvent into which an aggregating agent for aggregating the coloring material has been dissolved. In such a case, when the ink is ejected onto the recording medium S onto which the reaction solution has been ejected, then the aggregating agent of the reaction solution neutralizes the force of mutual Coulomb repulsion of the coloring material in the ink and causes the coloring material to aggregate together. This thickens the ink ejected onto the recording medium S, and raises the fixability of the ink to the recording medium S.

The reaction between the reaction solution and the ink is not limited to the aggregation of a coloring material by an aggregating agent as described above.

Water is preferable as the solvent of the reaction solution; in addition to water, a water-soluble organic solvent such as a polyhydric alcohol or polyhydric alcohol derivative may also be added.

As the aggregating agent, for example, a metal salt is preferable; in particular, a polyvalent metal salt is preferable from the viewpoint of cohesive force. Suitably usable examples of polyvalent metal salts include one or a plurality from among calcium nitrate, calcium chloride, magnesium chloride, calcium acetate, magnesium acetate, and calcium formate.

The evaporation promotion section 4 is provided with a blower section 25, a first heat insulating material 31 provided between the blower section 25 and the reaction solution application section 3, and a second heat insulating material 32 provided between the blower section 25 and the first head unit 17a. That is to say, the first heat insulating material 31 is provided more on the downstream side in the direction of feeding than the first position P1 and more on the upstream side in the direction of feeding than the third position P3. The second heat insulating material 32 is provided more on the downstream side in the direction of feeding than the third position P3 and more on the upstream side in the direction of feeding than the second position P2.

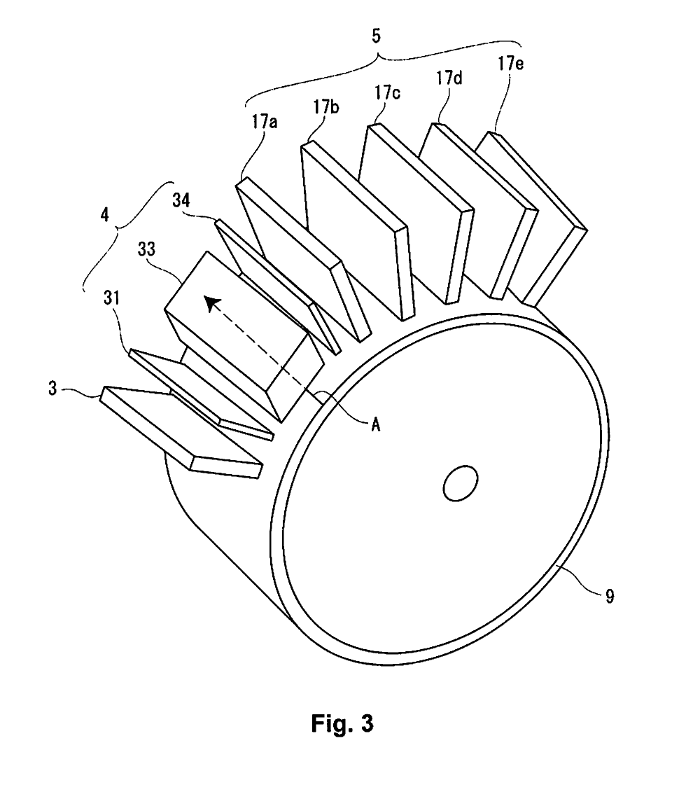

The blower section 25 has a blower section fan 33 and a blower section heater 34. The blower section fan 33 blows a wind, in an airflow direction A (see FIGS. 2 and 3) that is substantially parallel to the recording surface Sa and substantially orthogonal to the direction of feeding, onto the recording medium S onto which the reaction solution has been ejected. The blower section heater 34 heats the air that is blown onto the recording medium S. The blower section 25 promotes the evaporation of the solvent of the reaction solution ejected onto the recording medium S, by blowing hot air onto the recording medium S. For this reason, the ink is ejected, in a state where the solvent of the reaction solution has been evaporated to some extent, onto the recording medium S onto which the reaction solution has been ejected. As such, ejecting of ink onto the recording medium S in a state where a large amount of the solvent of the reaction solution remains on the recording medium S is curbed. Therefore, the fixing position accuracy for the ink on the recording medium S can be improved.

The blower section heater 34 is one example of a “blowing and heating section” in the claims.

Using the blower section heater 34 in combination to blow air heated above room temperature enables the blower section 25 to more effectively evaporate the solvent of the reaction solution. The blower section 25 may promote the evaporation of the solvent of the reaction solution by blowing room-temperature air using only the blower section fan 33.

A direction of blowing A in which the blower section 25 blows the hot air at the third position P3 is a direction that is substantially orthogonal to the direction of feeding of the recording medium S, and this makes it possible to curb blowing of hot air from the blower section 25 to the first position P1, which is more on the upstream side in the direction of feeding than the third position P3, and also makes it possible to curb blowing of hot air from the blower section 25 onto the second position P2, which is more on the downstream side in the direction of feeding than the third position P3. Therefore, it is possible to prevent the hot air coming from the blower section 25 from disrupting the ejecting of the reaction solution by the reaction solution application section 3 at the first position P1 or the ejecting of ink by the ink ejecting section 5 at the second position P2. More specifically, for example, drying of the reaction solution ejecting nozzles 24 of the reaction solution ejecting heads 23 provided to the first position P1 can be prevented, as can drying of the ink ejecting nozzles 19 of the ink ejecting head 18 provided to the second position P2.

The first heat insulating material 31 is constituted of a thermally insulating material and is formed in the shape of a plate. In a case where the heated air is blown onto the recording medium S at the third position P3, providing the first heat insulating material 31 curbs heating of the first position P1 in association therewith. As such, the hot air coming from the blower section 25 can be prevented from disrupting the ejecting of the reaction solution by the reaction solution application section 3 at the first position P1.

The first heat insulating material 31 could also be made to function as a shielding material for shielding the first position P1 from the hot air from the blower section 25.

Similarly, the second heat insulating material 32 is constituted of a thermally insulating material and is formed in the shape of a plate. In a case where the heated air is blown onto the recording medium S at the third position P3, providing the second heat insulating material 32 curbs heating of the second position P2 in association therewith. As such, the hot air coming from the blower section 25 can be prevented from disrupting the ejecting of the ink by the ink ejecting section 5 at the second position P2.

The second heat insulating material 32 could also be made to function as a shielding material for shielding the second position P2 from the hot air from the blower section 25.

Above, according to the recording apparatus 1 of the present embodiment, the first position P1 at which the reaction solution is applied onto the recording medium S by the reaction solution application section 3 and the second position P2 at which the ink is ejected onto the recording medium S by the ink ejecting section 5 are provided to the same outer peripheral surface feed path R that runs along the outer peripheral surface of the singular rotating drum 9. For this reason, it is possible to shorten the distance between the first position P1 at which the reaction solution is applied onto the recording medium S and the second position P2 at which the ink is ejected, in the path of feeding of the recording medium S. As such, it is possible to curtail the duration of time from after the reaction solution has been ejected until when the ink is ejected, with respect to a specific region of the recording medium S, and it also becomes possible to curtail the overall printing time. The recording apparatus 1 of the present embodiment also makes it possible to simplify the structure of the feed section 2 because the feed section 2 is provided with only one rotating drum 9, in comparison to a case where, unlike the present embodiment, the feed section 2 is provided with a plurality of rotating drums 9, i.e., in comparison to a case where the reaction solution is ejected by the reaction solution application section 3 at a first position P1 in one outer peripheral surface feed path R that runs along the outer peripheral surface of one rotating drum 9 and the ink is ejected by the ink ejecting section 5 at a second position P2 in another outer peripheral surface feed path R that runs along the outer peripheral surface of another rotating drum 9.

The present embodiment raises an example where the reaction solution is ejected in an inkjet format as the reaction solution application section 3 for applying the reaction solution onto the recording medium S, but the aspect of the reaction solution application section 3 is in no way limited thereto. The reaction solution application section 3 may be, for example, an aspect where the reaction solution is ejected in the form of a spray toward the recording medium S from a spray head, or may be an aspect where the recording medium S is coated with the reaction solution by a coating roller.

In the present embodiment, the evaporation promotion section 4 is a configuration provided with the blower section 25, but the evaporation of the solvent of the reaction solution having been ejected onto the recording medium S may be promoted by providing a medium heating section for heating the recording medium S at the third position P3 in addition to the blower section 25 or alternatively in place of the blower section 25. In such a case, for example, the medium heating section may be built into the rotating drum 9, or may be provided at a gap from the outer peripheral surface of the rotating drum 9.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A recording apparatus, comprising:
a drum with which a recording medium is fed along an outer peripheral surface;
a reaction solution application section configured to apply a reaction solution onto the recording medium at a first position in an outer peripheral surface feed path that runs along the outer peripheral surface of the drum; and
an ink ejecting section configured to eject an ink that reacts with the reaction solution onto the recording medium onto which the reaction solution has been applied, at a second position that is more on a downstream side in a direction of feeding of the recording medium than the first position, in the outer peripheral surface feed path.

2. The recording apparatus as set forth in claim 1, further comprising
an evaporation promotion section including at least one of a blower section configured to blow air onto the recording medium at a third position that is more on the downstream side of the direction of feeding than the first position and more on an upstream side of the direction of feeding than the second position in the outer peripheral surface feed path, and a medium heating section configured to heat the recording medium at the third position,
the evaporation promotion section being configured to promote evaporation of a solvent of the reaction solution having been applied to the recording medium.

3. The recording apparatus as set forth in claim 2, wherein the evaporation promotion section has at least the blower section.

4. The recording apparatus as set forth in claim 3, wherein the blower section is further configured to blow the air in a direction substantially orthogonal to the direction of feeding.

5. The recording apparatus as set forth in claim 3, wherein
the blower section includes a blowing and heating section configured to heat the air that is blown onto the recording medium.

6. The recording apparatus as set forth in claim 5, wherein
the evaporation promotion section further includes a first heat insulating material provided more on the downstream side in the direction of feeding than the first position and more on the upstream side in the direction of feeding than the third position.

7. The recording apparatus as set forth in claim 5, wherein
the evaporation promotion section further includes a second heat insulating material provided more on the downstream side in the direction of feeding than the third position and more on the upstream side in the direction of feeding than the second position.

8. The recording apparatus as set forth in claim 1, wherein
the reaction solution application section has a plurality of reaction solution ejecting nozzles that are configured to eject the reaction solution and arranged so as to correspond to a width of the drum.

9. The recording apparatus as set forth in claim 1, wherein
the ink ejecting section has a plurality of ink ejecting nozzles that are configured to eject the ink and arranged so as to correspond to a width of the drum.

10. The recording apparatus as set forth in claim 1, wherein
the drum is rotated by the recording medium being fed.

11. The recording apparatus as set forth in claim 1, further comprising
a medium feed-out section configured to feed the recording medium out toward the drum, and
a medium take-up section configured to take up the recording medium having been fed from the drum.
